(19) United States
(12) Patent Application Publication
(10) Pub. No.: US 2026/0367949 A1
(43) Pub. Date: Nov. 19, 2026

(54) Agentic System for Real-Time Simulation of REST APIs

(71) Applicant: ServiceNow, Inc., Santa Clara, CA (US)

(72) Inventors: Sai Vishwak Korimerla, Hyderabad (IN); Prerna Goyal, Punjab (IN)

(21) Appl. No.: 19/209,941

(22) Filed: May 16, 2025

(51) Int. Cl. G06F 9/455; G06F 9/54

(52) U.S. Cl. CPC G06F 9/455; G06F 9/542; G06F 2209/543

(57) ABSTRACT

A method includes receiving an application programming interface (API) request from a system under test. The method includes determining a simulated API response behavior based on contextual data associated with an API endpoint, one or more real-time data sources, and a natural language description defining aspects of a desired simulation scenario. The method includes generating, based on the determined simulated API response behavior, a simulated API response. The method includes transmitting the simulated API response to the system under test.

### TECHNICAL FIELD

This disclosure relates to configurable agent templating for collaborative environments.

### BACKGROUND

Modern software applications increasingly rely on integrations with various external and internal services through Application Programming Interfaces (APIs), such as Representational State Transfer (REST) APIs. Testing these integrations, particularly those involving complex, multi-step interactions like setting up conference calls or processing multi-stage transactions, is crucial for ensuring application reliability, performance, and overall quality. Robust testing verifies that an application behaves correctly even when interacting systems exhibit diverse behaviors.

Traditional methods for testing API integrations face significant limitations. Using real third-party services (e.g., actual video conferencing or messaging platforms) during testing can be costly, complex to manage, and impractical for simulating a wide range of error conditions or specific behavioral nuances. Alternatively, developers often employ static mocking techniques, using “mock servers” or “stubs” that return predefined, hardcoded responses. While useful for basic testing, static mocks require developers to manually define the expected behavior for each specific API call and interaction step. Manually identifying, coding, and maintaining static mocks for all possible scenarios and their subtle variations is often impractical, if not impossible, especially for intricate API interaction flows.

### SUMMARY

One aspect of the disclosure provides a method for real-time simulation of application programming interfaces (APIs). The method includes receiving an API request from a system under test. The method includes determining a simulated API response behavior based on contextual data associated with an API endpoint, one or more real-time data sources, and a natural language description defining aspects of a desired simulation scenario. The method includes generating, based on the determined simulated API response behavior, a simulated API response. The method includes transmitting the simulated API response to the system under test.

Implementations of the disclosure may include one or more of the following optional features. In some implementations, the contextual data is derived from prior interactions involving the API endpoint. In some of these examples, the prior interactions involving the API endpoint include API requests between the system under test and a target service corresponding to the API endpoint. Optionally, determining the simulated API response behavior comprises using a large language model (LLM).

In some examples, determining the simulated API response behavior includes dynamically generating one or more simulation heuristics. The simulation heuristics may include at least one of a simulated delay, a simulated error condition, or a simulated variation in interaction flow. In at least some of these examples, the dynamically generated one or more simulation heuristics simulate at least one of network issues, user behavior variations based on location or time zone, server load fluctuations, or varying numbers of participants in a simulated interaction.

Optionally, the one or more real-time data sources include at least one of data from the received API request, system logs, user information, or server load metrics. In some implementations, determining the simulated API response includes executing a tool call to retrieve external data missing from the contextual data or the one or more real-time data sources and determining the simulated API response behavior is further based on the retrieved external data. The tool call may be configured to retrieve at least one of current weather conditions based on a location associated with the simulation scenario or user state information based on user identifying information.

In some implementations, the contextual data includes data uniquely associated with the API endpoint. The method may further include adjusting a size of the contextual data based on at least one of selecting relevant portions of the contextual data based on the API request or chunking the contextual data.

Another aspect of the disclosure provides a system for real-time simulation of APIs. The system includes data processing hardware and memory hardware in communication with the data processing hardware. The memory hardware stores instructions that when executed on the data processing hardware cause the data processing hardware to perform operations. The operations include receiving an API request from a system under test. The operations include determining a simulated API response behavior based on contextual data associated with an API endpoint, one or more real-time data sources, and a natural language description defining aspects of a desired simulation scenario. The operations include generating, based on the determined simulated API response behavior, a simulated API response. The operations include transmitting the simulated API response to the system under test.

This aspect may include one or more of the following optional features. In some implementations, the contextual data is derived from prior interactions involving the API endpoint. In some of these examples, the prior interactions involving the API endpoint include API requests between the system under test and a target service corresponding to the API endpoint. Optionally, determining the simulated API response behavior comprises using a large language model (LLM).

In some examples, determining the simulated API response behavior includes dynamically generating one or more simulation heuristics. The simulation heuristics may include at least one of a simulated delay, a simulated error condition, or a simulated variation in interaction flow. In at least some of these examples, the dynamically generated one or more simulation heuristics simulate at least one of network issues, user behavior variations based on location or time zone, server load fluctuations, or varying numbers of participants in a simulated interaction.

Optionally, the one or more real-time data sources include at least one of data from the received API request, system logs, user information, or server load metrics. In some implementations, determining the simulated API response includes executing a tool call to retrieve external data missing from the contextual data or the one or more real-time data sources and determining the simulated API response behavior is further based on the retrieved external data. The tool call may be configured to retrieve at least one of current weather conditions based on a location associated with the simulation scenario or user state information based on user identifying information.

In some implementations, the contextual data includes data uniquely associated with the API endpoint. The operations may further include adjusting a size of the contextual data based on at least one of selecting relevant portions of the contextual data based on the API request or chunking the contextual data.

Another embodiment of the disclosure provides a computer-readable medium having instructions that, when executed by data processing hardware, causes the data processing hardware to perform operations. The operations include receiving an API request from a system under test. The operations include determining a simulated API response behavior based on contextual data associated with an API endpoint, one or more real-time data sources, and a natural language description defining aspects of a desired simulation scenario. The operations include generating, based on the determined simulated API response behavior, a simulated API response. The operations include transmitting the simulated API response to the system under test.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for real-time simulation of application programming interfaces (APIs).

FIG. 2 is a schematic view of exemplary components of an agentic framework of the system of FIG. 1.

FIG. 3 is an exemplary sequence diagram illustrating operation of the agentic framework of FIG. 2.

FIG. 4 is a flowchart of an example arrangement of operations for a method for real-time simulation of APIs.

FIG. 5 is a schematic view of an example computing device that may be used to implement the systems and methods described herein.

Like reference symbols in the various drawings indicate like elements.

### DETAILED DESCRIPTION

The field of software testing, particularly the testing of integrations between different software systems via application programming interfaces (APIs), particularly representational state transfer (REST) APIs, is critical for developing reliable and robust applications. Ensuring that an application correctly handles interactions with dependencies, such as third-party services (e.g., communication platforms, payment gateways) or internal microservices, requires thorough testing. However, existing methodologies for simulating these dependencies during testing present considerable challenges.

Conventional API mocking approaches predominantly rely on static configurations. Developers create mock servers that are programmed to return specific, predetermined responses when certain API requests are received. While this allows for basic functional verification, it falls short in replicating the dynamic and often unpredictable nature of real-world systems. These static mocks typically lack the ability to introduce realistic variations in response times, simulate intermittent network issues, model diverse user interaction patterns (e.g., users joining a conference call late or dropping off unexpectedly), or adapt behavior based on the broader context of the test or real-time environmental factors. Generating the necessary variations often requires significant manual effort to code specific heuristics for each potential scenario, limiting test coverage.

Testing directly against live production or staging environments of integrated services also presents difficulties. This approach can incur direct costs, requires managing potentially complex account setups and credentials, may be subject to rate limits or throttling by the external service, and often makes it difficult or impossible to trigger specific error conditions or edge-case behaviors needed for comprehensive testing.

Implementations herein provide an agentic framework for real-time simulation of APIs to overcome these limitations. The framework provides a dynamic, robust, and realistic simulation environment for testing API integrations. Instead of relying on static, hardcoded responses, these implementations may utilize an intelligent agent to dynamically generate simulated API response behaviors based on a combination of learned context, real-time data, and high-level descriptions (e.g., natural language) of the desired simulation scenario.

In some implementations, the framework includes receiving an API request from a system under test, where the request is directed to a simulated API endpoint. The framework determines a simulated API response behavior. This determination may be based on multiple factors: contextual data associated with the specific API endpoint (which may be derived from observing prior interactions involving that endpoint), one or more real-time data sources (such as data from the received API request itself, system logs, user information, or server load metrics), and a natural language description that defines aspects of the desired simulation scenario (e.g., focus on simulating network delays or specific user behaviors). Based on the determined behavior, a simulated API response is generated and transmitted back to the system under test.

The determination of the simulated API response behavior can be performed using an intelligent agent based on technologies such as large language models (LLMs) or other agentic frameworks. This agent may analyze the contextual data, real-time inputs, and the natural language description to dynamically generate one or more simulation heuristics in real-time. These heuristics can include simulated delays, simulated error conditions (e.g., returning specific HTTP error codes), or simulated variations in the interaction flow (e.g., mimicking a user failing to complete a step). These dynamically generated heuristics may simulate a wide range of real-world conditions, such as network issues, location or time-zone-based user behavior variations, server load fluctuations, or varying numbers of participants in a simulated interaction. Contextual data used by the agent is specifically associated with a target API endpoint and may be managed, for instance by selecting relevant portions or chunking, to optimize processing. This approach may use the gathered data as context for the agent's decision-making process, rather than requiring resource-intensive model training or fine-tuning.

In some implementations, the agent's process for determining the simulated API response behavior may involve executing a tool call to retrieve external data that is not available in the existing contextual data or configured real-time sources. This retrieved external data further informs the determination of the response behavior. For example, a tool call could be configured to fetch current weather conditions based on a location relevant to the simulation to model potential weather-related impacts or retrieve specific user state information based on identifying details provided in the request or context. This allows the simulation to incorporate highly dynamic, real-time external factors for enhanced realism.

Advantageously, this framework increases the realism and robustness of API integration testing compared to static methods. It enables improved test coverage by automatically generating a wide range of complex scenarios, edge cases, and behavioral heuristics that would be impractical or prohibitively time-consuming to hardcode manually. This leads to enhanced product quality, increased reliability, fewer integration failures in production, and potentially reduced system downtime. Furthermore, the automation of complex test variation generation improves testing efficiency, reducing the manual effort required to write and maintain mock code, potentially lowering development costs and contributing to a faster time-to-market.

Thus, this agentic framework moves beyond static, predetermined responses and fixed heuristics characteristic of traditional mocking. Instead, the framework provides dynamic adaptation and automated generation of diverse, realistic simulation heuristics. The framework may leverage a combination of learned contextual data (e.g., from observing real interactions for specific API endpoints), various real-time data sources, and flexible natural language guidance to make informed decisions about how to simulate behavior. This holistic data utilization and contextual analysis, combined with the framework's ability to automatically generate complex behavioral permutations, enhances existing static mocks or basic load simulators that typically rely on predefined rules or lack dynamic, context-aware adaptation.

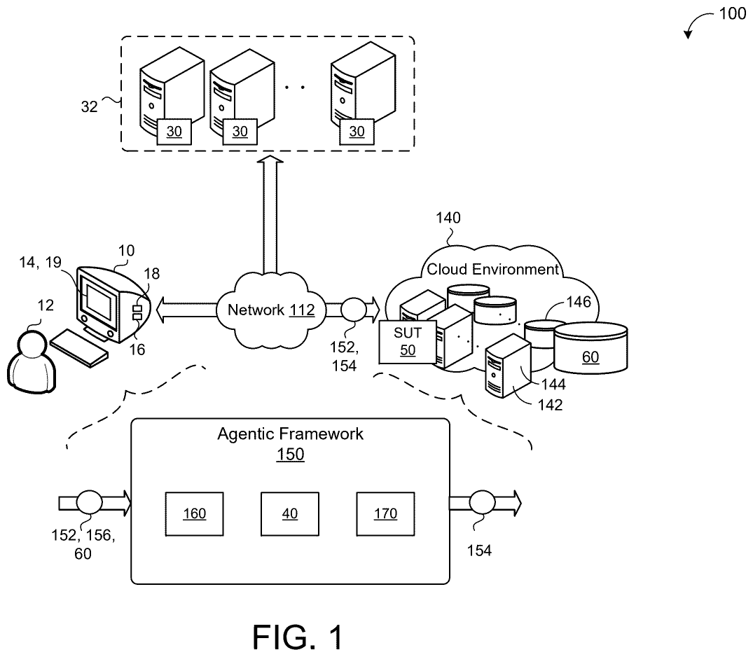

Referring to FIG. 1, in some implementations, a system 100 may include a remote system 140 in communication with one or more user devices 10 each associated with a respective user 12 via a network 112, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 148 (i.e., a remote storage device) may be overlain on the storage resources 146 to allow scalable use of the storage resources 146 by one or more of the clients (e.g., the user device 10) or the computing resources 144.

The remote system 140 is configured to communicate with the user device 10 via, for example, the network 112. The user device(s) 10 may correspond to any computing device, such as a desktop workstation, a laptop workstation, or a mobile device (i.e., a smart phone). Each user device 10 includes computing resources 18 (e.g., data processing hardware) and/or storage resources 16 (e.g., memory hardware). The data processing hardware 18 executes a graphical user interface (GUI) 19 for display on a screen 14 in communication with the data processing hardware 18.

An agentic framework 150 may be executed on the remote system 140, on a user device 10, or distributed between the remote system 140 and the user device 10. The agentic framework 150 is configured to simulate responses from one or more application programming interface (API) endpoints 30, providing a dynamic and realistic testing environment. As used herein, an “API endpoint” refers to a specific URI (Uniform Resource Identifier) or URL (Uniform Resource Locator) of a web service or application executed by one or more computing systems 32 (e.g., a web server or the like) that a client system (e.g., the user device 10 and/or the remote system 140) may interact with to perform operations (e.g., starting a conference when interacting with a conferencing service, or sending a message when interacting with a messaging service). The agentic framework 150 may serve as a mock or simulated version of such an endpoint 30.

In operation, the agentic framework 150 is configured to receive an API request 152. This request 152 may originate from a system under test (SUT) 50. The SUT 50 is an application or software component whose interactions with external and/or internal API-based services are being tested. For example, the SUT 50 is a notification service within an enterprise platform (e.g., hosted by the remote system 140) attempting to interact with a third-party conferencing service or a short message service (SMS) gateway. The API request 152 from the SUT 50, intended for a target service (e.g., the third-party conferencing service or SMS gateway), is instead directed to the agentic framework 150 simulating that target service's API endpoint 30.

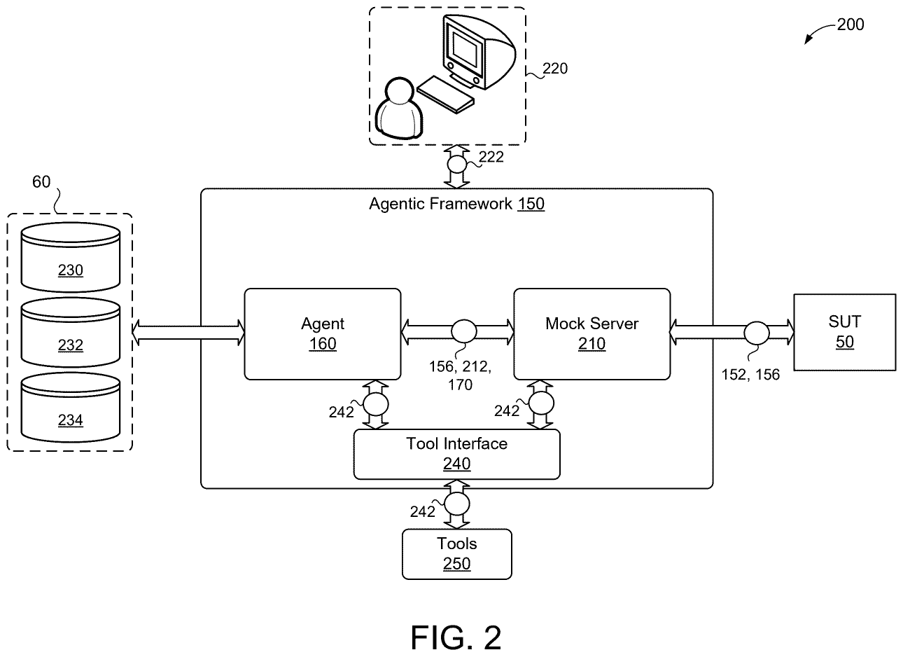

Upon receiving the API request 152, the agentic framework 150 determines a simulated API response behavior 40. This determination is a dynamic process, as opposed to static mocking, and is based on a combination of inputs. These inputs, in some examples, include: contextual data 156 associated with the specific API endpoint 30 being simulated (e.g., data capturing typical interaction sequences, timings, and variations for that endpoint 30); one or more real-time data sources 60 (e.g., information from the incoming API request itself, current system logs, user information such as location or time zone, server load metrics, or platform-specific data like incident priority); and/or a natural language description provided by a tester 220 (FIG. 2) such as, for example, the user 12 via the user device 10. This natural language description defines aspects of the desired simulation scenario, guiding the framework on what to simulate (e.g., “simulate a conference call start, considering user locations and potential delays”).

An intelligent agent 160, which may be a model (e.g., a neural network such as a large language model (LLM) or other agentic systems) processes the inputs to determine the simulated API response behavior 40. The contextual data 156 may be derived from prior, observed interactions involving the API endpoint 30, such as requests and responses between an SUT 50 and the actual target service, and/or may be scoped specifically to the API endpoint 30 being simulated. In some implementations, the agentic framework 150 adjusts a size or scope of the contextual data 156, for example, by selecting relevant portions based on the current API request 152 or by chunking the data for efficient processing by the agent 160.

Based on this determined behavior 40, the agentic framework 150 generates a simulated API response 154 and transmits this response 154 back to the SUT 50. The agentic framework 150 may generate the API response 154 dynamically by creating one or more simulation heuristics 170. Simulation heuristics 170 refer to rules, patterns, or characteristics that define the behavior of the simulated API. These can include, but are not limited to, simulating appropriate delays in response times, introducing simulated error conditions (e.g., HTTP error codes, specific error messages), or creating simulated variations in the expected interaction flow (e.g., a multi-step process where some steps succeed and others fail, or where participants in a simulated conference call behave differently). These dynamically generated heuristics 170 may simulate a wide range of real-world conditions, such as network issues (e.g., packet loss, high latency), user behavior variations (e.g., a user joining a call late due to their time zone, or not responding based on simulated environmental factors), server load fluctuations affecting response times, or varying numbers of participants successfully completing actions in a simulated interaction.

In some implementations, determining the simulated API response behavior 40 involves the intelligent agent 160 executing a tool call. This tool call allows the agent 160 to retrieve external data that may be missing from its existing contextual data 156 or configured real-time data sources 60 but is relevant for enhancing the realism of the simulation. For example, the agent 160 may call a tool to fetch current weather conditions for a user's simulated location to model potential weather-related network disruptions, or to look up a user's state or other regional information based on a phone number or country code to refine simulated user behavior. This retrieved external data further informs the agent's decision-making process for generating the simulated API response 154.

Thus, the system 100 depicted in FIG. 1, through the agentic framework 150, provides a sophisticated mechanism for API simulation. Instead of static mocking, the agentic framework 150 enables dynamic, context-aware, and guided generation of simulated API behaviors, which leads to more robust and comprehensive testing of software integrations.

Referring now to FIG. 2, a block diagram 200 illustrates an exemplary architecture of the agentic framework 150. The external SUT 50 initiates an API request 152, such as a REST API call, intended for a target service (e.g., a third-party service or an internal product API). This request is directed to a mock server 210. The mock server 210 acts as the simulated endpoint for the target service. The mock server 210 receives the incoming API request 152 from the SUT 50. The mock server 210 communicates with the agent 160 to determine how to respond to the SUT 50. For example, the mock server 210 sends a request context 212 to the agent 160 that is based on the API request 152. A tester 220, which may include a developer (e.g., a user 12) and/or automated test suite (e.g., executed by the remote system 140 or other device), may interact with the agentic framework 150, for instance, to provide a mock API description 222 (also referred to herein as a natural language description 222) or to initiate and/or monitor test runs. Once the agent 160 determines the simulated API response behavior 40 (e.g., by generating simulation heuristics 170), the mock server 210 generates and sends the simulated API response 154 back to the SUT 50.

Optionally, an orchestrating layer (not shown) may receive the request context 212 from the mock server 210 and interfaces with an agent 160 to obtain guidance on the simulation behavior. The orchestrating layer may be responsible for translating directives from the agent 160 into specific actions or responses for the mock server 210 to execute.

The agent 160 is responsible for dynamic simulation. The agent 160 may be implemented using various technologies, including LLMs, dedicated agent frameworks, or other AI-driven systems. The agent 160 determines the simulated API response behavior 40 based on one or more inputs. Optionally, the inputs include the mock API description 222. This description (e.g., provided by the tester 220 in natural language) outlines the desired focus or parameters of the simulation scenario (e.g., “simulate a conference call with participants joining late from different time zones” or “simulate an SMS send operation with intermittent network delivery delays”). This allows for flexible, high-level control over the simulation.

The agent 160 may use one or both of contextual data 156 and real-time data sources 60. This data may include learned context and/or logs 230, which represents data captured during a “learning phase.” In this phase, the agentic framework 150 (or a component thereof) observes real interactions between a test system (e.g., the SUT 50) and the actual target API endpoint 30 to be simulated. These observations, including request/response sequences, timings, and common variations, are logged and stored. This learned context 230 may be specific to particular API endpoints 30 and used by the agentic framework 150 (e.g., the agent 160) as real-world context for decision-making, rather than for training or fine-tuning a model. The agentic framework 150 may employ techniques such as selecting relevant portions of this data 230 or chunking the data 230 based on the specific incoming API request 152 to manage context size effectively. Further inputs to the agentic framework 150 may include any real-time data sources 60, such as real-time user information 232 (e.g., simulated user location, time zone, status) and real-time server load metrics 234 (e.g., current simulated server congestion levels). For example, these data sources encompass platform-specific data, such as an incident priority or data from the received API request 152 itself.

To enhance realism, the agentic framework 150, in some examples, leverages a tool calling interface 240. When the necessary information for a nuanced simulation is not available in the existing learned context 230 or other data sources 60, the agentic framework 150 (e.g., the agent 160), via the tool interface 240, may execute a tool call to interact with one or more tools 250. For example, the agentic framework 150 uses a tool to fetch current weather conditions for a simulated user's location to model potential weather-related network issues or look up detailed regional information based on a user's phone number. Data 242 retrieved via the tool calling interface 240 further informs the agent's behavioral determination.

Based on synthesis of the mock API description 222, the learned context 230, other various real-time data sources 60 (e.g., user information 232 and server load metrics 234), and/or any data 242 obtained via the tool calling interface 240, the agentic framework 150 (e.g., via the agent 160) may dynamically generate simulation heuristics 170. These heuristics 170 define the specific behavior of the mock response 154, such as introducing realistic delays, simulating transient or persistent errors, varying the number of successful participants in an interaction, or mimicking complex, multi-step interaction flows with diverse outcomes (e.g., network issues, user behavior variations based on location or time zone, server load fluctuations).

The dynamically generated heuristics 170 are passed from the agent 160 to the mock server 210 optionally via an orchestration layer. The mock server 210, based on the heuristics 170, transmits the appropriate simulated API response 154 to the SUT 50. Thus, the agentic framework 150 may automatically generate a wide array of realistic and complex test scenarios, moving beyond the capabilities of static mocking solutions by adapting its behavior based on a dynamic interplay of contextual data 156 and explicit guidance.

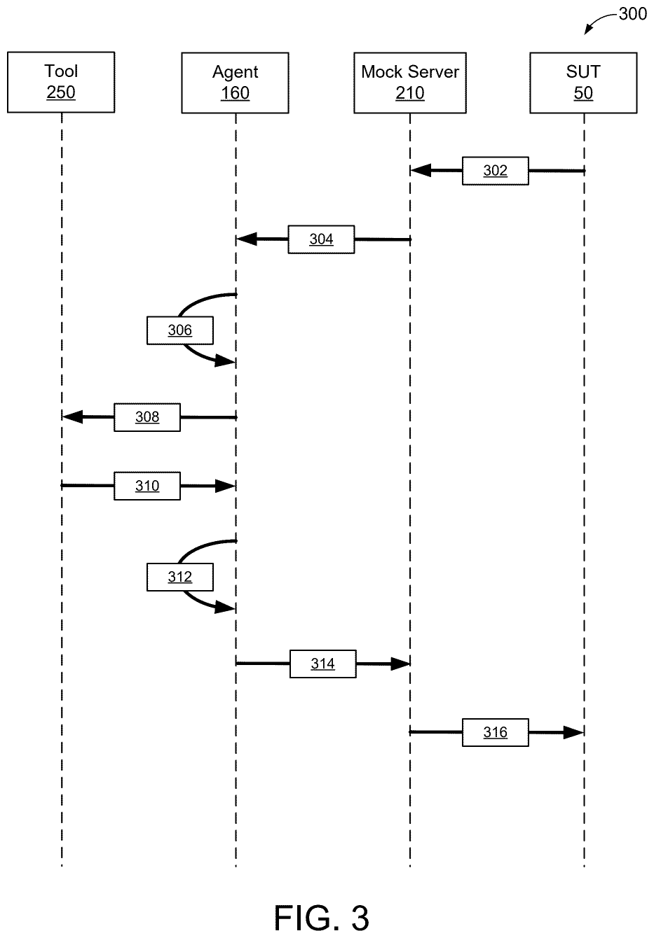

FIG. 3 illustrates an exemplary sequence diagram 300 illustrating the operational flow of the agentic mock server system during the processing of an API request 152 from a SUT 50. The sequence exemplifies how the agentic framework 150 may dynamically generate a simulated API response 154.

The process begins at step 302 when the SUT 50 sends an API request 152 to the mock server 210. In this example, the request is to initiate a new conference call (e.g., POST/api/conf_entity/start_conference). This request 152 may include parameters such as the meeting topic and a list of proposed participants. Upon receiving the API request 152, the mock server 210, at step 304, forwards the request details, or a relevant subset thereof, to the agent 160. This may include information identifying the specific API endpoint 30 being targeted.

The agent 160, at step 306, commences gathering the necessary inputs to determine the simulation behavior. For example, the agent 160 accesses the mock API description 222. This natural language description, previously defined by a tester, may specify, for instance, “Simulate a conference call initiation. One participant from Europe should experience a slight, weather-related connection delay. Other participants join normally but with realistic timing variations based on observed patterns. Emphasize simulating server load fluctuations affecting initial call setup time.”

Additionally or alternatively, the agent 160 retrieves relevant learned context 230. This context, which may be specific to the/api/conf_entity/start_conference endpoint 30, includes data from previously observed real interactions, such as typical API call sequences, response timings, and common variations encountered during call setups. The agent 160, still at step 306, may access one or more real-time data sources 60. This may include data from the incoming API request itself (e.g., participant identifiers), real-time user information 232 (e.g., pre-configured simulated locations or time zones for the given participant identifiers), and/or real-time server load metrics 234 (e.g., a current simulated load level for the mock service).

Optionally, to further enhance realism based on the mock API description 222 (e.g., “weather-related connection delay”), the agent 160, at step 308, may initiate a tool call to one or more tools 250 via the tool calling interface 240. For example, the tool call requests simulated current weather conditions for the European participant's location. The tool calling interface 240, at step 310, returns the requested external data 242 (e.g., “moderate rain, potential for minor network instability”) to the agent 160.

With these inputs (e.g., the mock API description 222, the learned context 230, any other real-time data sources 60, the external data 242), the agent 160, at step 312, determines and dynamically generates simulation heuristics 170. These heuristics 170 may include a variable delay for the initial call setup response based on the simulated server load and learned timings; a specific, slightly longer delay for the European participant's connection status to reflect the simulated weather impact; and/or variations in how other participants successfully connect.

The agent 160, at step 314, transmits the determined simulation heuristics 170 and the planned response structure to the mock server 210. The mock server 210 constructs the simulated API response 154 according to the received instructions (from the agent 160 or an intervening orchestration layer), incorporating the dynamically generated delays and behavioral characteristics. The mock server 210 transmits, at step 316, the simulated API response 154 (e.g., an HTTP 200 OK with conference details, possibly indicating the European participant is still connecting) back to the SUT 50. The internal state maintained by the mock server 210 or the agent 160 may reflect these dynamic decisions, influencing subsequent API calls related to this simulated conference.

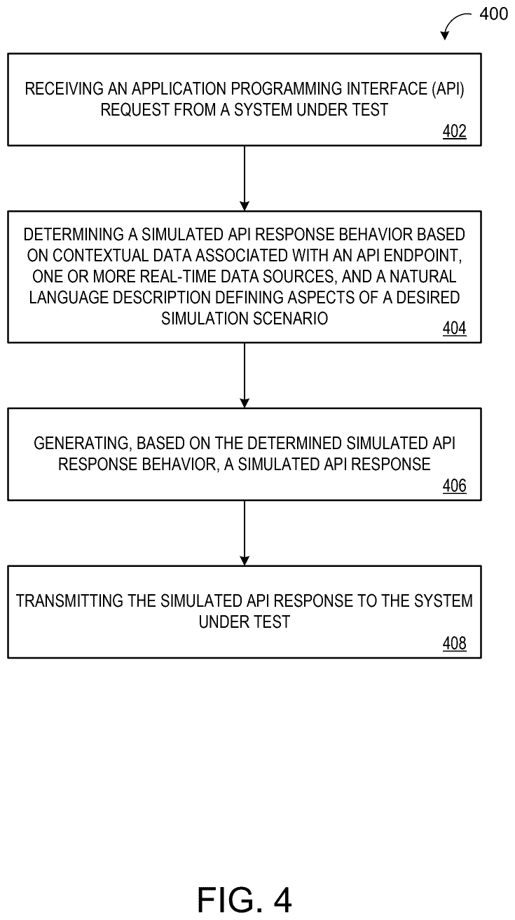

FIG. 4 is a flowchart of an exemplary arrangement of operations for a method 400 for real-time simulation of APIs. The method includes, at operation 402, receiving an API request 152 from a system under test 50. At operation 404, the method 400 includes determining a simulated API response behavior 40 based on contextual data 156 associated with an API endpoint 30, one or more real-time data sources 60, and a natural language description 222 defining aspects of a desired simulation scenario. The method 400, at operation 406, includes generating, based on the determined simulated API response behavior 40, a simulated API response 154. At operation 408, the method 400 includes transmitting the simulated API response 154 to the system under test 50.

The method 400 provides technical advantages and improvements over conventional API testing and mocking methodologies. For example, the determination of the simulated API response behavior 40 at operation 404, which relies on contextual data 156 specific to the API endpoint 30, one or more real-time data sources 60, and a natural language description 222, enables a dynamic and adaptive simulation capability that addresses the technical problem of insufficient realism and coverage in prior art static mocking approaches. In contrast to manually predefined, static responses or fixed heuristics, operation 404 allows the system 100 to automatically generate a diverse set of simulation heuristics 170 in real-time. This capability to consider multiple dynamic factors (e.g., learned patterns from contextual data 156, live inputs from real-time data sources 60, and/or high-level guidance from the natural language description 222) allows the method 400 to simulate a wide spectrum of complex real-world scenarios, including network latency variations, intermittent error conditions, diverse user interaction patterns (such as those influenced by simulated geographic locations or time zones), and fluctuations in server load, which would otherwise be impractical or impossible to comprehensively replicate through manual coding.

Furthermore, generating the simulated API response 154 at operation 406 based on this dynamically determined behavior 40 directly translates to an API testing environment of increased realism and robustness. This enhanced realism, stemming at least in part from the method's ability to automatically generate complex behavioral permutations, directly improves test coverage for edge cases and nuanced interaction flows. Such improved test coverage, in turn, leads to tangible technical benefits in the resulting software products, such as enhanced product quality, increased operational reliability of integrated systems, fewer unexpected failures in production environments, and consequently, potentially reduced system downtime. The method 400 also enhances the operational efficiency of computer systems executing software development and testing processes. By automating the generation of complex test variations, the manual effort traditionally required from developers to write, maintain, and update mock code is drastically reduced. Moreover, the reliance on contextual data 156 for informing the simulation, as opposed to requiring resource-intensive training or fine-tuning of complex machine learning models, makes the method 400 a more computationally efficient solution for achieving sophisticated and adaptive API simulations, thereby improving the overall functioning and resource utilization of the computer system executing the method.

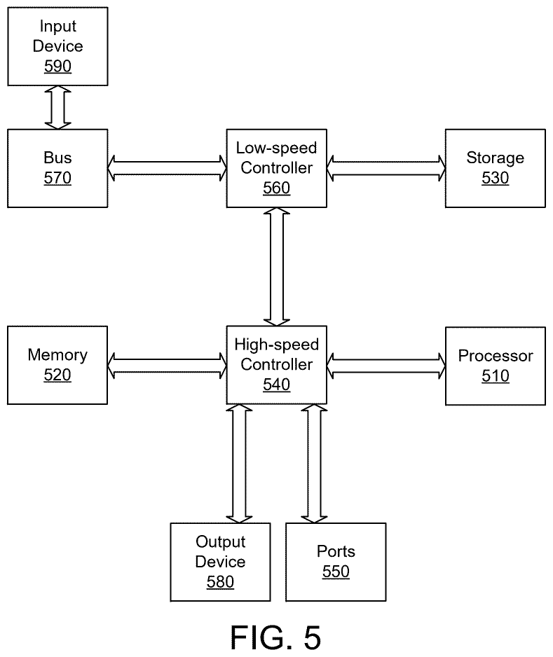

FIG. 5 is a schematic view of an example computing device 500 that may be used to implement the systems and methods described in this document. The computing device 500 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can execute instructions for performing operations within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server cluster, a group of blade servers, or a multi-processor system).

The memory 520 stores information within the computing device 500. The memory 520 may be a non-transitory computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 530 is capable of providing mass storage for the computing device 500. In some implementations, the storage device 530 is a non-transitory computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port or input device 590. The low-speed expansion port 590, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 500 may be implemented in a number of different forms, as shown in the figure. For example, it may be implemented as a standard server or multiple times in a group of such servers, as a laptop computer, or as part of a rack server system.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
receiving an application programming interface (API) request from a system under test;
determining a simulated API response behavior based on:
contextual data associated with an API endpoint;
one or more real-time data sources; and
a natural language description defining aspects of a desired simulation scenario;
generating, based on the determined simulated API response behavior, a simulated API response; and
transmitting the simulated API response to the system under test.

2. The method of claim 1, wherein the contextual data is derived from prior interactions involving the API endpoint.

3. The method of claim 2, wherein the prior interactions involving the API endpoint comprise API requests between the system under test and a target service corresponding to the API endpoint.

4. The method of claim 1, wherein determining the simulated API response behavior comprises using a large language model (LLM).

5. The method of claim 1, wherein determining the simulated API response behavior comprises dynamically generating one or more simulation heuristics, the simulation heuristics comprising at least one of:
a simulated delay;
a simulated error condition; or
a simulated variation in interaction flow.

6. The method of claim 5, wherein the dynamically generated one or more simulation heuristics simulate at least one of:
network issues;
user behavior variations based on location or time zone;
server load fluctuations; or
varying numbers of participants in a simulated interaction.

7. The method of claim 1, wherein the one or more real-time data sources include at least one of:
data from the received API request;
system logs;
user information; or
server load metrics.

8. The method of claim 1, wherein:
determining the simulated API response comprises executing a tool call to retrieve external data missing from the contextual data or the one or more real-time data sources; and
determining the simulated API response behavior is further based on the retrieved external data.

9. The method of claim 8, wherein the tool call is configured to retrieve at least one of:
current weather conditions based on a location associated with the simulation scenario; or
user state information based on user identifying information.

10. The method of claim 1, wherein the contextual data comprises data uniquely associated with the API endpoint.

11. The method of claim 1, further comprising adjusting a size of the contextual data based on at least one of:
selecting relevant portions of the contextual data based on the API request; or
chunking the contextual data.

12. A system comprising:
data processing hardware; and
memory hardware in communication with the data processing hardware, the memory hardware storing instructions that when executed on the data processing hardware cause the data processing hardware to perform operations comprising:
receiving an application programming interface (API) request from a system under test;
determining a simulated API response behavior based on:
contextual data associated with an API endpoint;
one or more real-time data sources; and
a natural language description defining aspects of a desired simulation scenario;
generating, based on the determined simulated API response behavior, a simulated API response; and
transmitting the simulated API response to the system under test.

13. The system of claim 12, wherein the contextual data is derived from prior interactions involving the API endpoint.

14. The system of claim 13, wherein the prior interactions involving the API endpoint comprise API requests between the system under test and a target service corresponding to the API endpoint.

15. The system of claim 12, wherein determining the simulated API response behavior comprises using a large language model (LLM).

16. The system of claim 12, wherein determining the simulated API response behavior comprises dynamically generating one or more simulation heuristics, the simulation heuristics comprising at least one of:
a simulated delay;
a simulated error condition; or
a simulated variation in interaction flow.

17. The system of claim 16, wherein the dynamically generated one or more simulation heuristics simulate at least one of:
network issues;
user behavior variations based on location or time zone;
server load fluctuations; or
varying numbers of participants in a simulated interaction.

18. The system of claim 12, wherein the one or more real-time data sources include at least one of:
data from the received API request;
system logs;
user information; or
server load metrics.

19. The system of claim 12, wherein:
determining the simulated API response comprises executing a tool call to retrieve external data missing from the contextual data or the one or more real-time data sources; and
determining of the simulated API response behavior is further based on the retrieved external data.

20. A computer-readable medium having instructions that, when executed by data processing hardware, causes the data processing hardware to perform operations comprising:
receiving an application programming interface (API) request from a system under test;
determining a simulated API response behavior based on:
contextual data associated with an API endpoint;
one or more real-time data sources; and
a natural language description defining aspects of a desired simulation scenario;
generating, based on the determined simulated API response behavior, a simulated API response; and
transmitting the simulated API response to the system under test.
